(19) United States
(12) Patent Application Publication
(10) Pub. No.: US 2014/0196876 A1
(43) Pub. Date: Jul. 17, 2014

(54) Header Tank, Heat Exchanger And Corresponding Method Of Assembly

(71) Applicant: Christian Riondet, Bourgogne (FR)

(72) Inventor: Christian Riondet, Bourgogne (FR)

(73) Assignee: Valeo Systemes Thermiques, Le Mesnil Saint Denis (FR)

(21) Appl. No.: 14/232,213

(22) PCT Filed: Jul. 11, 2012
(86) PCT No.: PCT/EP2012/063610

§ 371 Date: Mar. 27, 2014

(30) Foreign Application Priority Data
Jul. 12, 2011 (FR) 1156334

(51) Int. Cl. F28F 9/02; B23P 15/26

(52) U.S. Cl. CPC F28F 9/02; B23P 15/26
USPC 165/173; 29/890.043

(57) ABSTRACT

A header tank for a heat exchanger comprises a header plate (11) having openings (17) for the passage of a plurality of heat exchange tubes (5) and at least two end plates (7) on either side of the tubes (5), an elastic sealing means (13) arranged around the peripheral contour of the header plate (11), and a cover (15) having a cover base (25) which closes the header tank, thereby compressing the sealing means (13). The end plates (7, 107, 207) have, on the inside of the header plate (11, 111, 211), an axial extension of length (L′) greater than or equal to the height (h) of the sealing means (13, 113, 213). The sealing means (13, 113, 213) is arranged resting, under tension, against the end plates (7, 107, 207). The invention also relates to a heat exchanger comprising at least one such header tank, and to the method of assembling this heat exchanger.

The invention relates to a header tank for a heat exchanger, particularly for a motor vehicle.

The invention also relates to a heat exchanger comprising at least one such header tank and to a corresponding method of assembling the exchanger.

Heat exchangers used in motor vehicles, for example to cool the engine coolant are already known.

In general, such a heat exchanger comprises a core bundle of tubes and possibly fins interposed between the tubes, and two header tanks.

A header tank generally comprises at least two parts: a header plate that accepts the ends of the tubes and a cover that is fixed to the header plate to close the header tank.

All-metal header tanks are known as are, alternatively, tanks with a cover made of plastic.

The type of header tank that has a cover made of plastic requires a sealing means, conventionally an elastic gasket, to provide a perfectly sealed joint between the cover and the header plate.

In a known solution, the header plate may have a groove or slot in which the sealing means is placed and positioned. The cover is then positioned on the sealing means then the cover is fixed to the header plate to close the header tank.

As an alternative, there are flat header plates that have no groove or slot for notably making it easier to position the gasket and hold it in place. The expression “flat header plate” means that this header plate extends over a flat single surface, with the exception of any collars that may be conventionally provided as projections to accept the ends of the tubes. In particular, at its periphery, the header plate therefore has no groove or the like generally used to house the sealing means.

The main problem lies with positioning the gasket on the header plate before the cover is fitted because this operation of positioning the gasket is the main root cause of the difficulties encountered in production.

There are a number of possible reasons why the gasket may be incorrectly positioned. In particular, the gasket may exhibit a manufacturing defect which causes it to twist, this intrinsic defect in the gasket not being easy to spot because of the dimensions of the gasket or even because of its colour.

Moreover, if the gasket is too long, it will form ripples along its profile as the cover is fixed in place. This leads to somewhat unsatisfactory sealing and to leaks of fluid in the more of less long term.

Positioning the gasket is generally an operation performed by hand by an operator.

In one known solution, the gasket has protrusions situated at the four corners that allow the gasket to be stretched, these protrusions then being positioned in dedicated slots on the header plate. One major disadvantage with this solution lies in the need to create the slots at the various corners of the header plate, this representing an additional manufacturing cost and weakening the header plate, particularly reducing its resistance to cyclic pressure variations. Moreover, because the protrusions on the gasket protrude beyond the header tank, they increase the amount of space occupied by the header tank.

In another known solution pins are produced on the cover at the corners, these being intended to keep the gasket in shape, and possibly to keep it under tension. This solution makes it possible to ensure correct positioning of the gasket along the cover only with difficulty because the gasket can easily fall off while the cover is being handled before it is fitted to the header plate.

Another solution is moreover known in which the sealing means is arranged on at least two ends of tubes. However, for relatively large header tanks, the tubes may become deformed during the operation of crimping the cover to the header plate. Forces then being transmitted to the tubes by the gasket.

It is therefore an objective of the invention to alleviate these disadvantages of the header tanks of the prior art by proposing a solution for positioning a gasket on a header plate in a simple and reliable way.

To this end one subject of the invention is a header tank for a heat exchanger, comprising:
a header plate having openings for the passage of a plurality of heat exchange tubes and at least two end plates on either side of the said tubes,
an elastic sealing means arranged around the peripheral contour of the header plate, and
a cover having a cover base which closes the said header tank, thereby compressing the said sealing means,
   characterized in that:
the said end plates have, on the inside of the said header tank, an axial extension of length greater than or equal to the height of the said sealing means, and in that
the said sealing means is arranged resting, under tension, against the said end plates.

The said header tank may further comprise one or more of the following features, considered separately or in combination:
the said axial extension of an end plate inside the said header tank has a length substantially equal to the length of the said core bundle that protrudes inside the said header tank;
the said sealing means comprises a gasket;
the said header plate is more or less flat;
the said header plate comprises a peripheral groove to house the said sealing means;
the said groove has a bottom and two flanges, an outer flange and an inner flange, extending from the said bottom, and such that the said inner flange is fairly inclined with respect to the said bottom;
the said groove is roughly U-shaped overall;
the said header plate has at least two openings respectively configured to accept both the ends of an end plate and of the adjacent tube;
the said header plate has collars bordering the said openings.

The invention also relates to a heat exchanger, particularly for motor vehicles, comprising a heat exchange core bundle comprising a stack of parallel tubes and of at least two end plates of the said stack which are parallel to the said tubes, characterized in that the said exchanger further comprises at least one such header tank to which the said tubes and the said end plates are respectively fixed.

The said exchanger may further comprise one or more of the following features, considered separately or in combination:
the said end plates are more or less straight and are respectively spaced apart from the adjacent tube by a constant distance;
the said end plates are fairly curved, so that the distance between the end of an end plate and the end of the adjacent tube housed in the said header plate is substantially shorter than the distance between the said plate and the said adjacent tube on the outside of the said header plate.

The invention further relates to a method of assembling such a heat exchanger, characterized in that it comprises the following steps:
the said tubes are inserted into the associated openings in the said header plate,
the said end plates are inserted into the associated openings in the said header plate,
the said sealing means is stretched, and
the said sealing means is positioned under tension against the said end plates.

Other features and advantages de the invention will become more clearly apparent from reading the following description, given solely by way of nonlimiting illustration, and from studying the attached drawings among which:

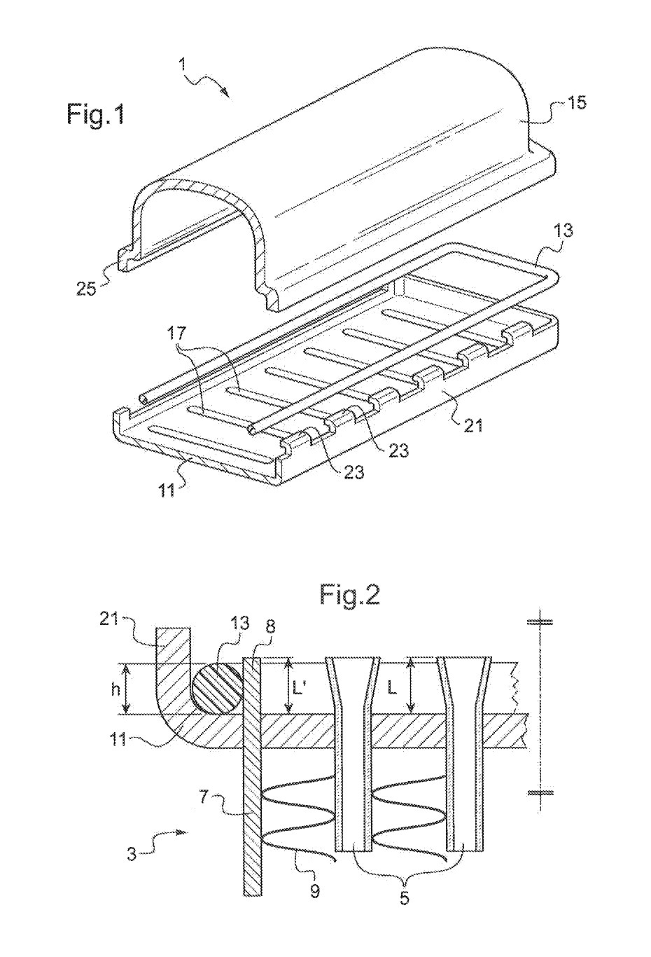

FIG. 1 is a simplified exploded view of a header tank according to a first embodiment,

FIG. 2 is a schematic view in cross section depicting a flat header plate of the header tank of FIG. 1,

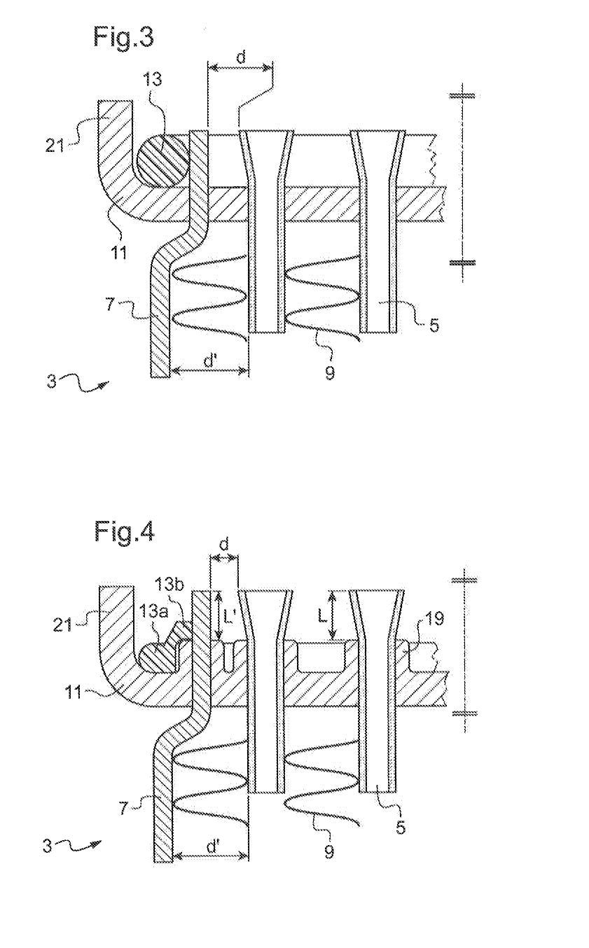

FIG. 3 is a schematic view in cross section depicting the header plate of FIG. 2 according to an alternative form of embodiment,

FIG. 4 is a schematic view in cross section depicting the header plate with collars according to another alternative form of embodiment,

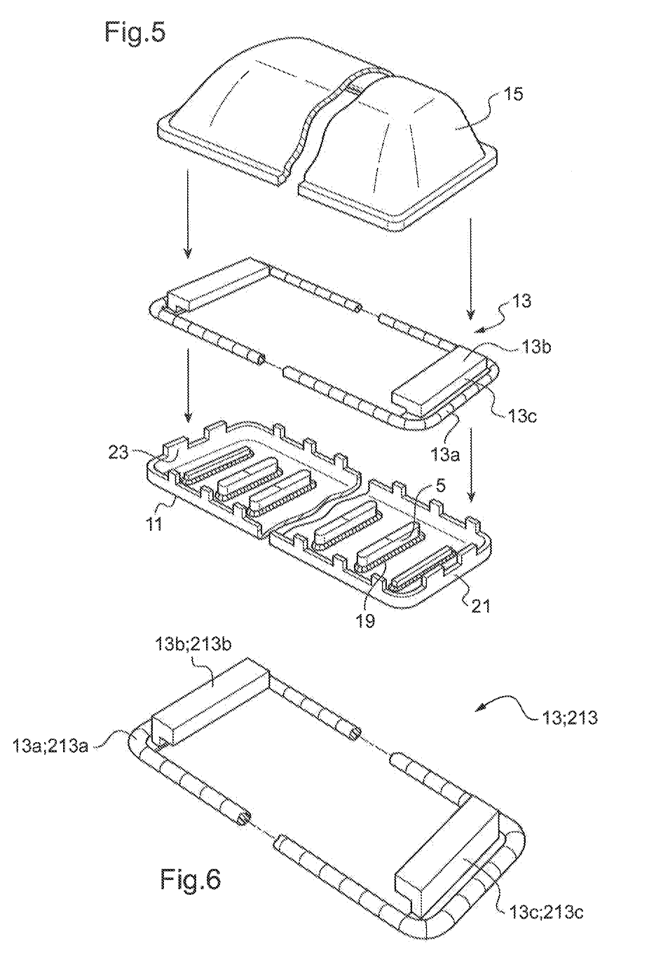

FIG. 5 is a simplified exploded view of the header tank with a header plate according to the alternative form of embodiment of FIG. 4,

FIG. 6 is a perspective view of a gasket that complements the header plate of FIGS. 4 and 5,

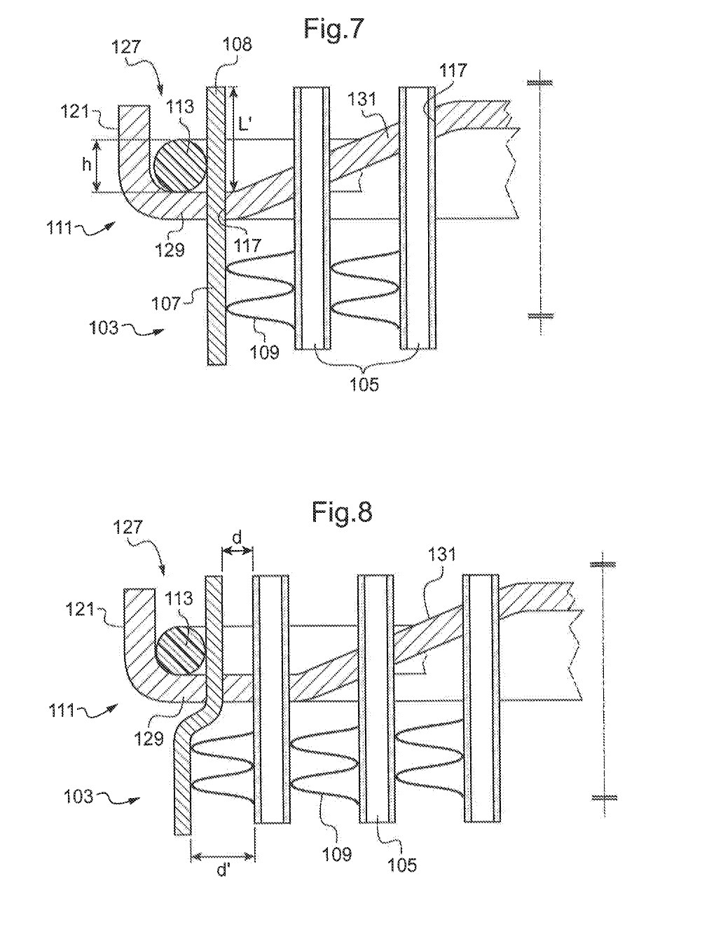

FIG. 7 is a schematic view in cross section depicting a header plate with a groove for housing a sealing means according to a second embodiment,

FIG. 8 is a schematic view in cross section depicting the header plate of FIG. 7 according to an alternative form of embodiment,

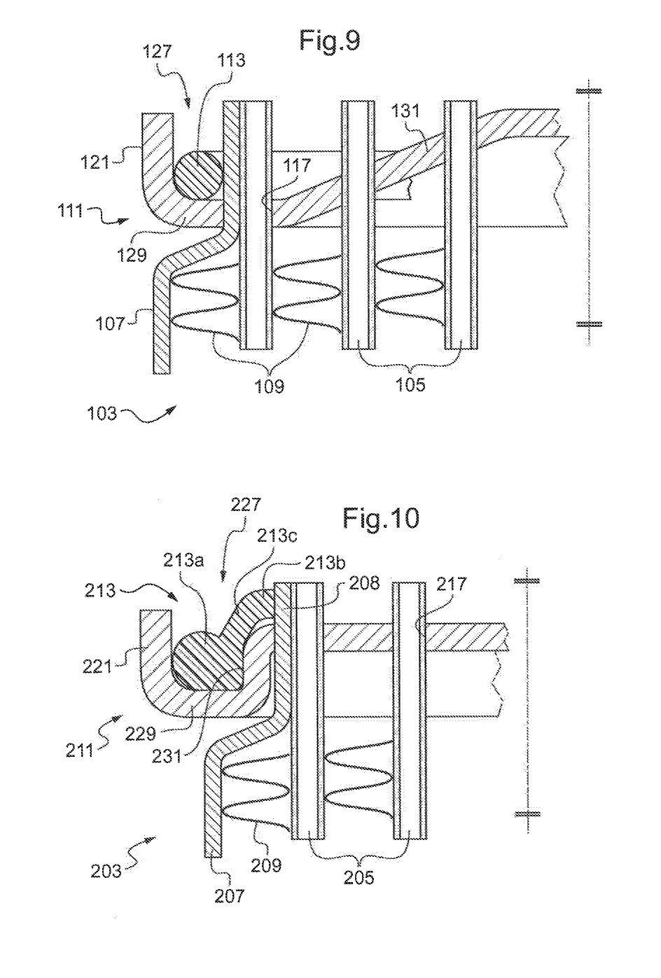

FIG. 9 is a schematic view in cross section depicting the header plate of FIG. 7 according to another alternative form of embodiment, and

FIG. 10 is a schematic view in cross section depicting a header plate with a U-shaped groove for housing a sealing means according to a third embodiment.

In these figures, the elements that are substantially identical bear the same references.

The elements of FIGS. 5 to 7 that correspond to the elements of FIGS. 1 to 4 bear the same references preceded by one in the hundreds.

Likewise, the elements of FIG. 10 that correspond to the elements of FIGS. 1 to 6 or 7 to 9 bear the same references preceded by two in the hundreds.

The invention relates to a heat exchanger for a motor vehicle, notably for cooling the engine coolant.

In particular, the invention may apply to a brazed heat exchanger.

FIG. 1 depicts, in the form of a schematic simplification, a first embodiment of a header tank 1 for a heat exchanger comprising a heat exchange core bundle 3 depicted partially and schematically in FIGS. 2 to 4.

The core bundle 3 comprises a stack of a multiplicity of tubes 5 which are arranged as one or more rows of tubes. Only the ends of the tubes 5 can be seen in FIGS. 2 to 4. The ends of the tubes 5 protrude into the header tank 1 by a length L.

The exchanger also has two end plates 7 one on either side of the stack of tubes 5. Only one end plate 7 is depicted in FIGS. 2 to 4.

An end plate 7 is different and distinct from a tube 5. Such an end plate 7 can therefore be distinguished from an end tube.

The difference lies in the fact that an end plate 7 has no flow duct for a fluid whereas the tubes 5 define flow ducts for a fluid.

In addition, as stated hereinabove, the exchanger may be fixed together for example by brazing. When such is the case, the end plates 7 are positioned at the ends of the core bundle 3 prior to the brazing operation.

Thus, the end plates 7 contribute to the grasping and holding of the core bundle by the apparatus used for the brazing operation.

Moreover, an end plate 7 has an axial extension 8 which protrudes into the header tank 1 by a length L′.

This length L′ may be more or less equal to the length L by which the tubes 5 of the core bundle 3 protrude.

Fins 9 interposed between two consecutive tubes 5 and between the end plates 7 and the adjacent tubes 5 may also be provided.

If they are, the end plates 7 also play a part in protecting the fins 9.

The end plates 7 are parallel to the tubes 5.

In addition, the end plates 7 may be more or less straight as illustrated in FIG. 2 or, as an alternative, may be fairly curved (cf. FIGS. 3 and 4) so as to reduce the amount of space occupied by the header tank 1.

What happens is that the end plates 7 are curved such that their ends come closer to the end of the adjacent tube 5. Thus, the distance d between the end of a plate 7 and the end of the adjacent tube 5 emerging into the header tank 1 is less than the distance d′ between the end plate 7 and the adjacent tube 5 over the remainder of the length.

The distance d may be near zero.

Referring once again to FIG. 1, the header tank 1 comprises:
a header plate 11
an elastic sealing means such as a gasket 13,
a cover 15, for example of substantially vaulted overall shape.

The gasket 13 is arranged around the peripheral contour of the header plate 11. The gasket 13 therefore has an overall shape that complements the shape of the peripheral contour of the header plate 11.

In the example illustrated in FIG. 1, the header plate has a substantially rectangular overall shape and the gasket 13 has a substantially rectangular overall shape. The gasket 13 may additionally be fairly rounded at the corners. Furthermore, according to the embodiment, the gasket 13 has a substantially circular cross section.

The gasket 13 is stretched then placed in contact with the end plates 7 once it has been tensioned. Because the end plates 7 lie on either side of the stack of tubes 5, they are therefore situated at the longitudinal ends of the header plate 11.

The header plate 11 has openings 17 for the passage of the ends of the tubes 5 and of the ends of the end plates 7.

Thus, the tubes 5 protrude inside the header plate 11 via the openings 17 by a protruding length L.

Likewise, the axial extension 8 protrudes inside the header plate 11 by a length L′.

This length L′ is greater than or equal to the height h of the gasket 13 and may be substantially equal to the length L via which the tubes 5 protrude.

Moreover, the header plate 11 may have collars 19 (cf. FIGS. 4 and 5) bordering the openings 17 to accept the ends of the tubes 5 and of the end plates 7.

When it does, as can be seen in FIGS. 4 and 6, the gasket 13 has, respectively at its longitudinal ends, a peripheral first part 13a and a contact second part 13b that forms a protrusion that is raised in comparison with the peripheral first part 13a. This contact protrusion 13b is configured to overhang the collar 19 (cf. FIG. 4) that accepts the end of an end plate 7, so as to press against this end plate 7.

The gasket 13 may have a connecting portion 13c connecting the peripheral part 13a and the contact part 13b.

Moreover, when the end plates 7 are curved so that their ends come closer to those of the adjacent tubes 5, the corresponding openings 17 are therefore also closer together.

In addition, in order to reduce still further the overall space required for the header tank 1, provision may be made for each end plate 7 to be housed in the same opening 17 as the adjacent tube 5.

To achieve that, the header plate 11 has two openings 17 which are larger in size by comparison with the other openings; these are the openings 17 situated at the ends, which here are longitudinal with reference to the drawings.

These larger-sized openings 17 are configured to accept both the end of a tube 5 and the end of an end plate 7.

According to the first embodiment illustrated in FIGS. 1 to 4, the header plate 11 is flat. It therefore has no groove to accept the gasket 13.

The header plate 11 has raised or bent-over edges 21 defining a housing for the gasket 13 in the same plane as the openings 17.

Crimping tabs 23 are provided on the raised edges 21 of the header plate 11 to be crimped to the edges of the cover 15.

In addition, the cover 15 has a cover base 25. This is the lower part of the cover 15 which presses against the gasket 13.

The gasket 13 (depicted in schematic and simplified form) is therefore positioned around the peripheral contour of the header plate 11 between the cover base 25 and the header plate 11.

Furthermore, the gasket 13 may have a shape that complements the shape of the cover base 25 and is always present between the cover base 25 and the header plate 11. There is therefore no direct contact between the cover base 25 and the header plate 11.

The cover base 25 further collaborates with the header plate 11 to be fixed, for example using the crimping tabs 23 present on the periphery or the perimeter of the header plate 11 and which are bent over, at the time of crimping, onto the cover 15.

The cover 15 can thus close the header tank 1 thereby compressing the gasket 13.

Moreover, the extensions 8 of the end plates 7 are depicted here as being substantially straight. Of course, another shape, for example fairly curved, that is suitable for contributing to holding the gasket 13 in place, could also be envisioned.

The second embodiment illustrated in FIGS. 7 to 9 differs from the first embodiment in that the header plate 111 is not flat but has a groove 127 to house the gasket 113.

This housing groove 127 has a bottom 129 and two flanges, an outer flange 121 and an inner flange 131, which extend from this bottom 129.

The outer flange forms the turned-up edge 121 of the header plate 111.

The inner flange 131, which means to say the one on the inside of the header plate 111, is, according to this second embodiment, fairly inclined with respect to the overall plane defined by the bottom 129 of the groove 127, so that it forms a continuous slope.

The bottom 129 has, in the example illustrated, an opening 117 to accept the end of an end plate 107. Of course, an opening 117 is provided symmetrically to accept the end of the other end plate 107.

Likewise, the header plate 111 has openings 117 all along the slope formed by the inner flange 131 to accept the ends of the tubes 105.

Quite clearly, in a similar way to the first embodiment, the end plates 107 may be more or less straight (FIG. 7) or fairly curved to bring them closer to the ends of the tubes 105 (cf. FIGS. 8 and 9).

In addition or as an alternative, the end plates 107 may be respectively housed in an opening 117 that is common to the adjacent tube 105 (FIG. 9).

Likewise, the axial extensions 108 of the end plates 107 have a length L′ inside the header tank that is greater than or equal to the height h of the gasket 113 and, for example, substantially equal to the length L by which the core bundle 103 protrudes inside the header tank.

Furthermore, and in a similar way to the first embodiment, the openings 117 may or may not be bordered by collars.

The third embodiment illustrated in FIG. 10 differs from the second embodiment in that the housing groove 227 is substantially U-shaped overall.

In this case, the inner flange 231 is substantially parallel to the outer flange forming the turned-up edge 221 of the header plate 211. The two flanges 221 and 231 are substantially perpendicular to the bottom 229 of the groove 227.

As in the first and second embodiments, the axial extensions 208 of the end plates 207 have a length L′ inside the header tank that is greater than or equal to the height h of the gasket 213 and for example substantially equal to the length L by which the core bundle 203 protrudes into the header tank.

The end plates 207 may also be substantially straight or curved. Further, each end plate 207 may also be housed in one and the same opening 217 as the adjacent tube 205, as illustrated by FIG. 10.

When this is the case, as FIGS. 6 and 10 illustrate, the gasket 213 has, at its longitudinal ends, a peripheral first part 213a housed in the groove 227 and a contact second part 213b configured to overhang the inner flange 231 of the groove 227 so that it presses against this end plate 7.

The gasket 213 may have a connecting portion 213c connecting the peripheral part 213a and the contact part 213b.

This alternative form of embodiment is substantially similar to the embodiment of the gasket 13 according to the first embodiment with collars 19 bordering the openings 17 (cf. FIGS. 5, 6).

Quite obviously, according to this third embodiment, the openings 217 also may or may not be bordered with collars.

The successive steps in assembling a heat exchanger comprising a heat exchange core bundle 3, 103, 203 with a sack of parallel tubes 5, 105, 205 and two end plates 7, 107, 207 parallel to the tubes 5, 105, 205 and placed on either side of the stack, and further comprising at least one header tank 1 as described hereinabove is now described.

In a first step, the ends of the tubes 5, 105, 205 and of the end plates 7, 107, 207 are introduced into the associated openings 17, 117, 217 in the header plate 11, 111, 211.

When the plate 11, 111, 211 has two openings 17, 117, 217 at the periphery of the plate 11, 111, 211 which have a larger dimension suited to accepting both the end of a tube 5, 105, 205 and the end of an end plate 7, 107, 207, these two ends are introduced into such an opening.

The core bundle 3, 103, 203 and the end plates 7, 107, 207 can then be brazed to the header plate 11, 111, 211. The end plates 7, 107, 207 contribute to the grasping and holding of the core bundle for performing this brazing operation.

In a second step, the gasket 13, 113, 213 is then positioned on the peripheral contour of the header plate 11, 111, 211 in contact with the end plates 7, 107, 207.

To do that, the gasket 13, 113, 213 is picked up and stretched first of all, for example by hand or even automatically, before it is placed in contact with the end plates 7, 107, 207 once it has been tensioned. The stretched gasket 13, 113, 213 is therefore placed under tension so that it has dimensions greater than the dimensions it has at rest and so that it can easily be set in position on the header plate 11, 111, 211.

Thus, in the next step, the gasket 13, 113, 213 is positioned under tension against the end plates 7, 107, 207.

The header tank 1 can then be closed, thereby compressing the gasket 13, 113, 213, using the cover 15 and, for example, the header plate 11, 111, 211 can be crimped to this cover 15.

When the exchanger comprises a second header tank 1 according to the invention, the same operations are carried out for fixing the core bundle 3, 103, 203 to the second header tank 1.

According to another embodiment, the exchanger may be of the mechanically assembled type.

In such a case, a sealing means such as a coated gasket which extends over the header plate 11, 111, 211 can be provided. Such a coated gasket seals the openings 17, 117, 217 in the header plate 11, 111, 211 which serve to accommodate the ends of the tubes 5, 105, 205 and the ends of the end plates 7, 107, 207.

It will therefore be appreciated that such a header tank 1 facilitates the positioning of the gasket 13, 113, 213 by placing it under tension before it is positioned against the end plates 7, 107, 207, something that allows the gasket 13, 113, 213 to be held in place correctly on the peripheral contour of the header plate until the cover 15 is fitted to close the header tank 1.

Furthermore, such a header tank 1 may occupy a smaller amount of space if the shape of the end plates 7, 107, 207 is varied to bring them closer to the adjacent tubes 5, 105, 205.

1. A header tank for a heat exchanger, the header tank comprising:
a header plate (11, 111, 211) having openings (17, 117, 217) for the passage of a plurality of heat exchange tubes (5, 105, 205) and at least two end plates (7, 107, 207) on either side of the tubes (5, 105, 205),
an elastic sealing means (13, 113, 213) arranged around the peripheral contour of the header plate (11, 111, 211), and
a cover (15) having a cover base (25) which closes the header tank, thereby compressing the sealing means (13, 113, 213), wherein
the end plates (7, 107, 207) have, on the inside of the header tank, an axial extension (8, 108, 208) of length (L′) greater than or equal to the height (h) of the sealing means (13, 113, 213), and
the sealing means (13, 113, 213) is arranged resting, under tension, against the end plates (7, 107, 207).

2. A header tank according to claim 1, wherein the axial extension (8, 108, 208) of an end plate (7, 107, 207) inside the header tank has a length (L′) substantially equal to the length (L) of the core bundle that protrudes inside the header tank.

3. A header tank according to claim 1, wherein the sealing means (13, 113, 213) comprises a gasket.

4. A header tank according to claim 1, wherein the header plate (11, 111, 211) is substantially flat.

5. A header tank according to claim 1, wherein the header plate (11, 111, 211) comprises a peripheral groove (127, 227) to house the sealing means (13, 113, 213).

6. A header tank according to claim 5, wherein the groove (127) has a bottom (129) and two flanges, an outer flange (121) and an inner flange (131), extending from the bottom (129), and wherein the inner flange (131) is fairly inclined with respect to the bottom (129).

7. A header tank according to claim 5, wherein the groove (227) is roughly U-shaped overall.

8. A header tank according to claim 1, wherein the header plate (11, 111, 211) has at least two openings (17, 117, 217) respectively configured to accept both the ends of an end plate (7, 107, 207) and of the adjacent tube (5, 105, 205).

9. A header tank according to claim 1, wherein the header plate (11, 111, 211) has collars (19) bordering the openings (17, 117, 217).

10. A heat exchanger comprising a heat exchange core bundle (3, 103, 203) comprising a stack of parallel tubes (5, 105, 205) and of at least two end plates (7, 107, 207) of the stack which are parallel to the tubes (5, 105, 205), wherein the heat exchanger further comprises at least one header tank (1) according to claim 1 to which the tubes (5, 105, 205) and the end plates (7, 107, 207) are respectively fixed.

11. A heat exchanger according to claim 10, wherein the end plates (7, 107, 207) are more or less straight and are respectively spaced apart from the adjacent tube (5, 105, 205) by a constant distance.

12. A heat exchanger according to claim 10, wherein the end plates (7, 107, 207) are curved, so that the distance (d) between the end of an end plate (7, 107, 207) and the end of the adjacent tube (5, 105, 205) housed in the header plate (11, 111, 211) is substantially shorter than the distance (d′) between the plate (7, 107, 207) and the adjacent tube (5, 105, 205) on the outside of the header plate (11, 111, 211).

13. A method of assembling a heat exchanger according to claim 10, the method comprising the following steps:
inserting the tubes (5, 105, 205) into the associated openings (17, 117, 217) in the header plate (11, 111, 211),
inserting the end plates (7, 107, 207) into the associated openings (17, 117, 217) in the header plate (11, 111, 211),
stretching the sealing means (13, 113, 213), and
positioning the sealing means (13, 113, 213) under tension against the end plates (7, 107, 207).
